(19) United States
(12) Patent Application Publication
(10) Pub. No.: US 2018/0324779 A1
(43) Pub. Date: Nov. 8, 2018

(54) DATA TRANSMISSION METHOD AND A BASE STATION

(71) Applicant: YULONG COMPUTER TELECOMMUNICATION SCIENTIFIC (SHENZHEN) CO., LTD. (CN), Shenzhen (CN)

(72) Inventors: Mingju LI, Shenzhen (CN); Yunfei ZHANG, Shenzhen (CN)

(73) Assignee: YULONG COMPUTER TELECOMMUNICATION SCIENTIFIC (SHENZHEN) CO., LTD. (CN), Shenzhen (CN)

(21) Appl. No.: 15/970,883

(22) Filed: May 4, 2018

(30) Foreign Application Priority Data
May 5, 2017 (CN) 201710313088.6

(51) Int. Cl. H04W 72/04; H04L 1/00; H04L 1/16; H04L 1/18; H04L 5/00

(52) U.S. Cl. CPC H04W 72/044; H04W 72/042; H04L 1/008; H04L 5/0044; H04L 1/1819; H04L 5/0055; H04L 1/1664

(57) ABSTRACT

A data transmission method and a base station are disclosed. The method includes sending a first indication signal, a second indication signal and a third Transport Block through a base station to a first terminal under the condition that a second time-frequency resource contained in a first time-frequency resource previously allocated to the first terminal is allocated to a second terminal, wherein, the first time-frequency resource is used for transmitting a first Transport Block of the first terminal, and the second time-frequency resource is used for transmitting a second Transport Block of the second terminal; the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to; the second indication signal is used for indicating a location of a third time-frequency resource allocated to the third Transport Block by the base station; the third Transport Block contains the data, which is previously planned to be transmitted on the second time-frequency resource, from the first Transport Block. Accordingly, data transmission efficiency can be increased.

### CROSS REFERENCE

This application claims priority of Chinese Patent Application No. 201710313088.6 filed on May 5, 2017, entitled “A data transmission method and a base station”, which is incorporated herein by reference in its entirety.

### TECHNICAL FIELD

The present disclosure relates to the field of communication technology, and in particular relates to a data transmission method and a base station.

### BACKGROUND

In a system of Long Time Evolution (LTE), data is transmitted in basic units of Transport Blocks (TBs), and one TB corresponds to one feedback of Hybrid Automatic Repeat request (HARQ), which is acknowledgement (ACK) or negative acknowledgement (NACK). If the HARQ feedback corresponding to one TB is NACK, the entire TB needs to be retransmitted. Thus, even if one TB is divided into multiple Code Blocks (CBs) to be sent, under the condition that only one CB is falsely transmitted, the HARQ feedback corresponding to this TB would still be NACK, and therefore the entire TB would need to be retransmitted, which adversely affects data transmission efficiency.

New Radio (NR) technology supports multiple types of services such as enhanced Mobile BroadBand (eMBB), massive Machine Type Communications (mMTC), and Ultra-Reliable and Low Latency Communications (URLLC).

Because NR needs to simultaneously support multiple types of services, diversity multiplexing with respect to time-frequency resource needs to be carried out for the multiple types of services, for example, diversity multiplexing for eMBB service and URLLC service. In particular, a base station allocates N Resource Blocks (RBs) of one Slot to a TB of User Equipment 1 on eMBB service, and when sending data and Downlink Control Information contained in this TB, a service of User Equipment 2 on URLLC service suddenly arrived in the middle of Slot 1. Because URLLC service has higher requirement of time delay, the base station is required to immediately allocate resource to the User Equipment 2 on URLLC service in order to meet the strict time-delay requirement for URLLC service. If the base station allocates part of symbols in the middle of this Slot to the User Equipment 2, the data or Downlink Control Information of the User Equipment 1 is no longer transmitted in the duration of this part of symbols, but instead the data or Downlink Control Information of the User Equipment 2 is transmitted in the duration of this part of symbols. Thus it can be seen that, part of the data in one TB of the User Equipment 1 has not been transmitted, that is to say, with the technical solution of the prior art, part of the data in one TB is lost and the received HARQ feedback would be NACK, and as a result, the base station needs to retransmit the entire TB, which reduces the data transmission efficiency.

### SUMMARY

One aspect of the present disclosure provides a data transmission method and a base station that can avoid retransmission of the entire first Transport Block through the base station, by indicating and transmitting a Transport Block that contains the data which is previously planned to be transmitted on the occupied time-frequency resource to the first terminal, so as to increase data transmission efficiency.

A first aspect of the embodiments of the present disclosure provides a data transmission method that comprises:

sending a first indication signal, a second indication signal and a third Transport Block through a base station to a first terminal under the condition that a second time-frequency resource contained in a first time-frequency resource previously allocated to the first terminal is allocated to a second terminal,
wherein, the first time-frequency resource is used for transmitting a first Transport Block of the first terminal, and the second time-frequency resource is used for transmitting a second Transport Block of the second terminal;
the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to;
the second indication signal is used for indicating a location of a third time-frequency resource allocated to the third Transport Block by the base station; the third Transport Block contains the data, which is previously planned to be transmitted on the second time-frequency resource, from the first Transport Block.

Another aspect of the present disclosure provides a base station that comprises:

a sending module, for sending a first indication signal, a second indication signal and a third Transport Block to a first terminal under the condition that a second time-frequency resource contained in a first time-frequency resource previously allocated to the first terminal is allocated by the base station to a second terminal;
wherein, the first time-frequency resource is used for transmitting a first Transport Block of the first terminal, and the second time-frequency resource is used for transmitting a second Transport Block of the second terminal;
the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to;
the second indication signal is used for indicating a location of a third time-frequency resource allocated to the third Transport Block by the base station; the third Transport Block contains the data, which is previously planned to be transmitted on the second time-frequency resource, from the first Transport Block.

In a possible design, the structure of the base station comprises a processor and a transceiver, wherein the processor is for executing the method provided by the first aspect of the present application. Optionally, a memory is also comprised, the memory is for storing application program codes for supporting the base station to execute the above-mentioned method, and the processor is configured to execute the application program codes stored in the memory.

A third aspect provides a computer storage medium with program codes stored therein, and when executed by a computer device, the program codes execute the data transmission method provided by the first aspect. The storage medium includes, but not limited to, a flash memory, a Hard Disk Drive (HDD), or a Solid State Drive (SSD).

In the embodiments of the present disclosure, the names of the first terminal, the second terminal and the base station are only exemplary. Other devices having equivalent functions are included in the scope of the Claims of the present application and equivalent technology thereof.

In some embodiments, under the condition that a second time-frequency resource contained in a first time-frequency resource previously allocated to the first terminal is allocated to a second terminal, the base station indicates and transmits a Transport Block that contains the data which is previously planned to be transmitted on the occupied time-frequency resource to the first terminal, so as to avoid the situation that the base station retransmits the entire first Transport Block to the first terminal, and thus the data transmission efficiency is increased.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic diagram of possible network architecture provided by the embodiments of the disclosure;

FIG. 2 is a flow chart of a data transmission method provided by the embodiments of the disclosure;

FIG. 3 is a flow chart of another data transmission method provided by the embodiments of the disclosure;

FIG. 4A is a schematic diagram of an example of a first time-frequency resource provided by the embodiments of the disclosure;

FIG. 4B is a schematic diagram of an example of a second time-frequency resource provided by the embodiments of the disclosure;

FIG. 5 is a structural schematic diagram of a base station provided by the embodiments of the disclosure;

FIG. 6 is a structural schematic diagram of another base station provided by the embodiments of the disclosure.

### DETAILED DESCRIPTION

Reference will now be made in detail to the exemplary embodiments, examples of which are illustrated in the accompanying drawings.

It should be noted that, the terms used in some embodiments are only intended for the purpose of describing a specific embodiment, and are not intended to be limiting. The singular forms of “a”, “the”, “said” used in the embodiments of used in this specification and the appended Claims are intended to also include plural forms, unless clearly indicated otherwise in the context. It should also be understood that, the term “and/or” used in this specification refers to any or all of possible combinations of one or more related items listed. Also, the terms “first”, “second”, “third”, “fourth” used in the specification, Claims and Drawings of the present disclosure are intended to distinguish different objects, and are not intended to describe a specific sequence. Furthermore, the terms “comprise”, “have” and any grammatical variants thereof are intended to be non-exclusive, for example, a process, method comprising a series of steps or a system, product, device comprising a series of units is not limited to the steps or units that have been listed, but can optionally include steps or units that have not been listed, or can optionally include other steps or units that are inherent in this process, method, product or device.

In order to make the present disclosure easy to understand, hereinafter, a diagram of an exemplary network architecture is introduced first. Referring to FIG. 1, the network architecture as shown includes multiple types of services, including a base station and multiple User Equipments (UEs), such as UE1, UE2 and UE3. The respective UEs may support the same type of service, or may support different types of services.

For example, UE1 supports eMBB service, UE2 supports URLLC service, and when the base station transmits data or Downlink Control Information of a corresponding service to UE1 or UE2, the base station needs to allocate time-frequency resource to UE1 and UE2. In practical application, the URLLC service has higher requirement of time delay than the eMBB service (i.e. the URLLC service has shorter time delay than the eMBB service). Hence, under the condition that the base station allocates N Resource Blocks (RBs) of one Slot to a TB of UE1 on eMBB service, when data and Downlink Control Information contained in this TB is sent, a service of UE2 on URLLC service suddenly arrived in the middle of this Slot, because URLLC service has higher requirement of time delay, the base station is required to immediately allocate resource to UE2 on URLLC service, in order to meet the strict time-delay requirement for URLLC service, and if the base station allocates part of symbols in the middle of this Slot to UE2, the data or Downlink Control Information of UE1 is no longer transmitted in the duration of this part of symbols, but instead the data or Downlink Control Information of UE2 is transmitted in the duration of this part of symbols. Thus it can be seen that, part of the data in one TB of UE1 has not been transmitted, that is to say, with the technical solution of the prior art, part of the data in one TB is lost and the received HARQ feedback would be NACK, and as a result, the base station needs to retransmit the entire TB, which reduces the data transmission efficiency.

In some embodiments, under the condition that the base station allocates a second time-frequency resource contained in a first time-frequency resource previously allocated to UE1 is allocated to UE2, the base station sends a first indication signal, a second indication signal and a third Transport Block through a base station to UE1. Wherein, the first time-frequency resource is used for transmitting a first Transport Block of UE1, and the second time-frequency resource is used for transmitting a second Transport Block of UE2; the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to; the second indication signal is used for indicating a location of a third time-frequency resource allocated to the third Transport Block by the base station; the third Transport Block contains the data, which is previously planned to be transmitted on the second time-frequency resource, from the first Transport Block. In this way, retransmission of the entire first Transport Block through the base station to UE1 is avoided by means of indicating and transmitting a Transport Block that contains the data which is previously planned to be transmitted on the occupied time-frequency resource to UE1, so that the data transmission efficiency is improved.

The disclosed scheme may be applied in wireless network architecture that supports multiple types of services, such as a Global System for Mobile Communication (GSM), a Universal Mobile Telecommunication System (UMTS), a wireless communication system for future 5G, or other wireless communication systems.

The User Equipment, first terminal and second terminal not only include electronic devices with telecommunication function such as a cellphone, a Pad, a smart wearable device (e.g. watch, bracelet), and a Virtual Reality (VR) device, but also include electronic devices such as a motor vehicle, a non-motor vehicle, other telecommunication devices on a road, and a smart home appliance.

The base station in some embodiments may include, but not limited to, a base station device, a roadside unit, and a network side device for future 5G communication. Wherein, the base station may have different names in different systems, i.e. the base station may appear with another name. As long as the functions of the respective devices are analogous to the present application, they should be included in the scope of the Claims of the present application and equivalent technology thereof.

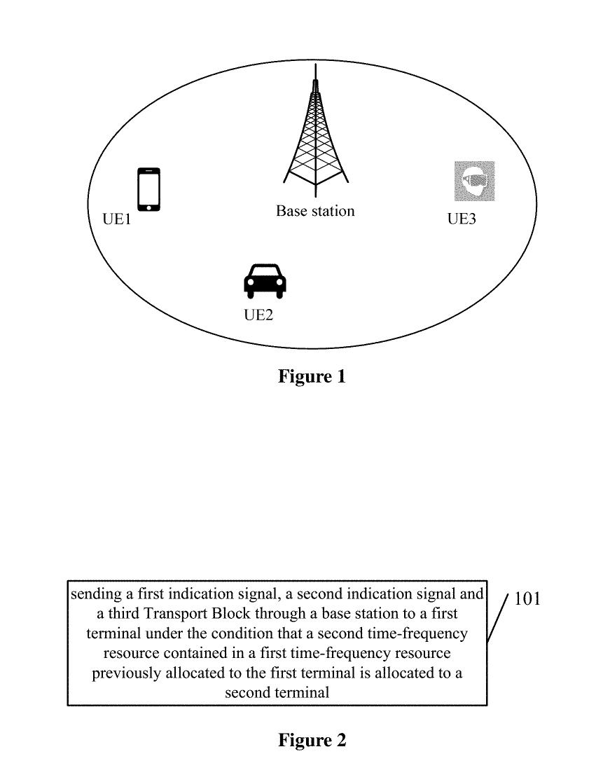

FIG. 2 is a flow chart of a data transmission method consistent with some embodiments of the present disclosure. As shown in FIG. 2, the disclosed data transmission method includes step 101, which is performed by a base station, and its specific process is described in detail below.

In step 101, the base station sends a first indication signal, a second indication signal and a third Transport Block through a base station to a first terminal under the condition that a second time-frequency resource contained in a first time-frequency resource previously allocated to the first terminal is allocated to a second terminal.

In particular, the base station allocates the first time-frequency resource to a first Transport Block of the first terminal. Wherein, the first Transport Block comprises data and/or Downlink Control Information to be sent to the first terminal, and the base station transmits the first Transport Block to the first terminal via the first time-frequency resource allocated. During the process of transmitting the first Transport Block through the base station to the first terminal via the first time-frequency resource, if a second Transport Block for the second terminal arrives, because of the time-delay requirement corresponding to the second Transport Block or other reasons, the second Transport Block needs to be transmitted timely, therefore, the base station would allocate part of or all of the resource in the first time-frequency resource, which is previously allocated to the first terminal, to the second terminal. After the base station allocates part of or all of the resource in the first time-frequency resource to the second terminal, the base station transmits the second Transport Block to the second terminal via a second time-frequency resource, wherein, the second time-frequency resource refers to the resource allocated to the second terminal from the first time-frequency resource.

In addition, after the first time-frequency resource is occupied by the second terminal, the base station sends a first indication signal, a second indication signal and a third Transport Block to the first terminal. Wherein, the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to; the second indication signal is used for indicating a location of a third time-frequency resource allocated to the third Transport Block by the base station; the third Transport Block contains the data, which is previously planned to be transmitted on the second time-frequency resource, from the first Transport Block. In this way, after the first terminal receives the first indication signal, the Code Block Group, Code Block or Code Block part not received in the first Transport Block can be determined, the non-reception may be caused after another Transport Block occupies the time-frequency resource thereof; subsequently, after the first terminal receives the second indication signal, the location of the third time-frequency resource of the third Transport Block can be notified, and thus the third Transport Block can be received according to the location of the third time-frequency resource notified. In this way, after the first time-frequency resource for the first terminal is occupied by another Transport Block, the data integrity can be ensured by transmitting a Transport Block that contains the data which is previously planned to be transmitted on the occupied time-frequency resource, this avoids retransmission of the entire first Transport Block to the first terminal, and thus the data transmission efficiency is increased.

Optionally, the base station uses Downlink Control Information (DCI) to announce the location of the first time-frequency resource allocated to the first Transport Block, in particular: the base station sends a fourth Downlink Control Information to the first terminal, wherein the fourth Downlink Control Information is for indicating the location of the first time-frequency resource, in order for the first terminal to receive the first Transport Block according to the indicated location of the first time-frequency resource.

Optionally, the base station uses DCI to announce the location of the second time-frequency resource allocated to the second Transport Block, in particular: the base station sends a fifth Downlink Control Information to the second terminal, wherein the fifth Downlink Control Information is for indicating the location of the second time-frequency resource, in order for the second terminal to receive the second Transport Block according to the indicated location of the second time-frequency resource.

In an optional embodiment, the second indication signal contains a subsequent transmission indicator for indicating that the third Transport Block is lag data.

In another optional embodiment, under the condition that an HARQ ACK/NACK feedback related to the first Transport Block is not received from the first terminal before the base station sends the second indication signal and the third Transport Block to the first terminal, the second indication signal carries a first new transmission indicator for indicating that the third Transport Block is new data.

In another optional embodiment, under the condition that an HARQ ACK/NACK feedback related to the first Transport Block is received from the first terminal before the base station sends the second indication signal and the third Transport Block to the first terminal, the second indication signal carries a second new transmission indicator for indicating that the third Transport Block is retransmitted data.

In an optional embodiment, the first indication signal and the second indication signal are sent to the first terminal via different information signals, and the embodiments have no limitation on the information signals used by the first indication signal and the second indication signal. For example, the first indication signal and the second indication signal are sent via Downlink Control Information, wherein, the first indication signal is contained in a first Downlink Control Information to be sent to the first terminal, and the second indication signal is contained in a second Downlink Control Information to be sent to the first terminal.

In another optional embodiment, the first indication signal and the second indication signal are sent to the first terminal via the same information signal. For example, the first indication signal and the second indication signal are sent via Downlink Control Information, in particular, the base station sends a third Downlink Control Information to the first terminal, wherein, the third Downlink Control Information is used for indicating the location of the second time-frequency resource occupied by the second Transport Block or indicating data, which is previously planned to be transmitted on the second time-frequency resource, in the first Transport Block, or a Code Block that the data belongs to, or a Code Block Group that the data belongs to; and the third Downlink Control Information is also used for indicating the location of the third time-frequency resource, in order for the first terminal to receive the third Transport Block according to the indicated location of the third time-frequency resource. Optionally, the third Downlink Control Information carries a subsequent transmission indicator for indicating that the third Transport Block is lag data; or, the third Downlink Control Information carries a new transmission indicator.

The new transmission indicator can be classified into a first new transmission indicator and a second new transmission indicator, in particular: under the condition that an HARQ ACK/NACK feedback related to the first Transport Block is not received from the first terminal before the base station sends the second indication signal and the third Transport Block to the first terminal, the third indication signal carries a first new transmission indicator for indicating that the third Transport Block is new data; under the condition that an HARQ ACK/NACK feedback related to the first Transport Block is received from the first terminal before the base station sends the second indication signal and the third Transport Block to the first terminal, the third indication signal carries a second new transmission indicator for indicating that the third Transport Block is retransmitted data.

Furthermore, optionally, the third Transport Block contains the data previously planned to be transmitted on the second time-frequency resource from the first Transport Block. The third Transport Block may only contain the data previously planned to be transmitted on the second time-frequency resource from the first Transport Block; or, it may contain a CB that the data previously planned to be transmitted on the second time-frequency resource from the first Transport Block belongs to; or, it may contain a CBG that the data previously planned to be transmitted on the second time-frequency resource from the first Transport Block belongs to. In order to increase the transmission efficiency for the data previously planned to be transmitted on the second time-frequency resource, a manner with the least data amount to be transmitted may be selected for transmitting the data previously planned to be transmitted on the second time-frequency resource from the first Transport Block. The base station may indicate, in the information signal of the second indication signal, that a CBG, CB or CB-part corresponding to the first Transport Block is included in a basic transmission unit CBG of the third Transport Block. Since the transmitted data is identical to the data previously planned to be transmitted in the first Transport Block, combined decoding is facilitated.

In some embodiments, under the condition that the base station allocates a second time-frequency resource contained in a first time-frequency resource previously allocated to the first terminal is allocated to the second terminal, the base station sends a first indication signal, a second indication signal and a third Transport Block to the first terminal. Wherein, the first time-frequency resource is used for transmitting a first Transport Block of the first terminal, and the second time-frequency resource is used for transmitting a second Transport Block of the second terminal; the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to; the second indication signal is used for indicating a location of a third time-frequency resource allocated to the third Transport Block by the base station; the third Transport Block contains the data, which is previously planned to be transmitted on the second time-frequency resource, from the first Transport Block. In this way, retransmission of the entire first Transport Block through the base station to the first terminal is avoided by means of indicating and transmitting a Transport Block that contains the data which is previously planned to be transmitted on the occupied time-frequency resource to the first terminal, so that the data transmission efficiency is improved.

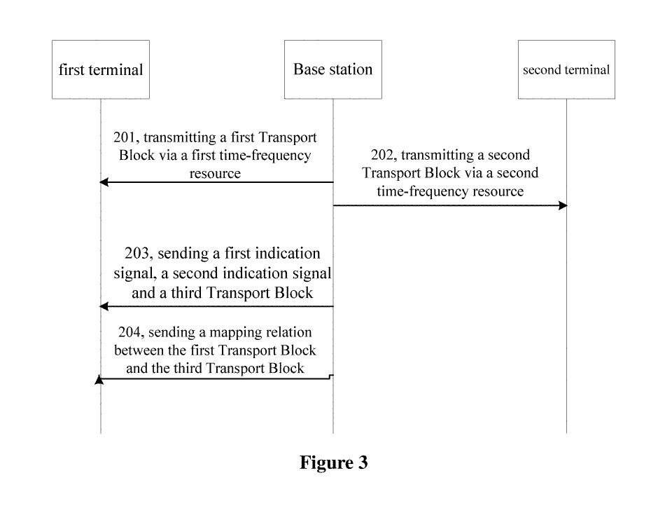

FIG. 3 is a flow chart of another exemplary data transmission method consistent with some embodiments of the present disclosure. As shown in FIG. 3, the disclosed data transmission method comprises Steps 201 to 204, which are carried out together by a base station, a first terminal and a second terminal, and its specific process is described in detail below.

In Step 201, a base station transmits a first Transport Block to a first terminal via a first time-frequency resource.

In particular, the base station allocates the first time-frequency resource to the first Transport Block of the first terminal. The first Transport Block comprises data and/or Downlink Control Information to be sent to the first terminal. For example, the first time-frequency resource allocated is one Resource Block (RB) comprising 12 continuous subcarriers with respect to frequency domain and one Slot with respect to time domain, wherein one Slot has 7 symbols. Furthermore, the base station transmits the first Transport Block to the first terminal via the first time-frequency resource allocated.

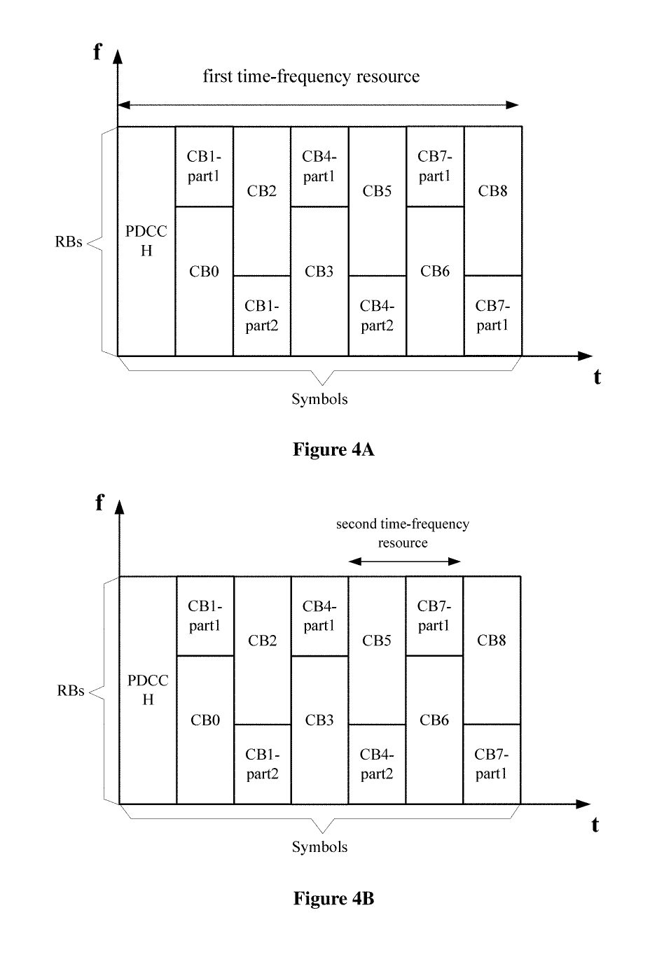

FIG. 4A is a schematic diagram of an example of a first time-frequency resource consistent with some embodiments of the present disclosure. As shown in FIG. 4A, the first time-frequency resource is one RB, and as for time domain, the first time-frequency resource comprises 7 symbols. The first symbol is used for writing prefix information such as Physical Downlink Control Channel (PDCCH), and the subsequent six symbols is used for writing the first Transport Block. Wherein, a Transport Block may comprise at least one Code Block (CB), and a Code Block may comprise at least one Code Block part. As shown in the figure, the first Transport Block comprises CB0, CB1-part1, CB1-part2, CB2, CB3, CB4-part1, CB4-part2, CB5, CB6, CB7-part1, CB7-part2, wherein, the Code Block part is named with part1 and part2, for example, CB1-part1 and CB1-part2 are two Code Block parts of CB1. It can be seen that, every Code Block and every Code Block part has corresponding time-frequency resource. The base station can transmit Code Blocks and Code Block parts according to the time-frequency resource associated with the respective Code Blocks and Code Block parts.

Optionally, the time-frequency resource involved in some embodiments may be expressed in different forms such as Resource Element (RE), for example, in an LTE system, a subcarrier with respect to frequency domain or a symbol with respect to time domain may be called an RE. Herein, there is no limitation on the expression forms of time-frequency resource.

Optionally, the base station uses Downlink Control Information to announce the location of the first time-frequency resource allocated to the first Transport Block, in particular: the base station sends a fourth Downlink Control Information to the first terminal, wherein the fourth Downlink Control Information is for indicating the location of the first time-frequency resource, in order for the first terminal to receive the first Transport Block according to the indicated location of the first time-frequency resource.

202, the base station transmits a second Transport Block to a second terminal via a second time-frequency resource.

In particular, during the process of transmitting the first Transport Block through the base station to the first terminal via the first time-frequency resource, if a second Transport Block for the second terminal arrives, because of the time-delay requirement corresponding to the second Transport Block or other reasons, the second Transport Block needs to be transmitted timely, therefore, the base station would allocate part of or all of the resource in the first time-frequency resource, which is previously allocated to the first terminal, to the second terminal. After the base station allocates part of or all of the resource in the first time-frequency resource to the second terminal, the base station transmits the second Transport Block to the second terminal via a second time-frequency resource, wherein, the second time-frequency resource refers to the resource allocated to the second terminal from the first time-frequency resource.

FIG. 4B is a schematic diagram of an example of a second time-frequency resource consistent with some embodiments of the present disclosure. As described with reference to FIG. 4A, the first time-frequency resource is one RB, and as for time domain, the first time-frequency resource comprises 7 symbols. As shown in FIG. 4B, the base station allocates two symbols in the first time-frequency resource to the second terminal, for transmitting the second Transport Block to the second terminal, wherein, the time-frequency resource of the two symbols occupied by the second terminal in the first time-frequency resource is the second time-frequency resource, which is the time-frequency resource of CB4-part2, CB5, CB6, CB7-part1 in the first Transport Block.

Optionally, the base station uses DCI to announce the location of the second time-frequency resource allocated to the second Transport Block, in particular: the base station sends a fifth Downlink Control Information to the second terminal, wherein the fifth Downlink Control Information is for indicating the location of the second time-frequency resource, in order for the second terminal to receive the second Transport Block according to the indicated location of the second time-frequency resource.

203, the base station sends a first indication signal, a second indication signal and a third Transport Block to the first terminal.

In particular, after the first time-frequency resource is occupied by the second terminal, the base station sends a first indication signal, a second indication signal and a third Transport Block to the first terminal. Wherein, the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to; the second indication signal is used for indicating a location of a third time-frequency resource allocated to the third Transport Block by the base station; the third Transport Block contains the data, which is previously planned to be transmitted on the second time-frequency resource, from the first Transport Block. In this way, after the first terminal receives the first indication signal, the Code Block or Code Block part not received in the first Transport Block can be determined, the non-reception may be caused after another Transport Block occupies the time-frequency resource thereof; subsequently, after the first terminal receives the second indication signal, the location of the third time-frequency resource of the third Transport Block can be notified, and thus the third Transport Block can be received according to the location of the third time-frequency resource notified. In this way, after the first time-frequency resource for the first terminal is occupied by another Transport Block, the data integrity can be ensured by transmitting a Transport Block that contains the data which is previously planned to be transmitted on the occupied time-frequency resource, this avoids retransmitting the entire first Transport Block to the first terminal, and thus the data transmission efficiency is increased.

In an optional embodiment, the second indication signal contains a subsequent transmission indicator for indicating that the third Transport Block is lag data. For example, the Transport Block sent through the base station to the first terminal may have three types of status, the first status is that the Transport Block has data initially transmitted, under this condition, the second indication signal carries a first new transmission indicator for indicating this Transport Block is new data; the second status is that the Transport Block has data transmitted for the first time after the resource becomes occupied by another Transport Block, under this condition, the second indication signal carries a subsequent transmission indicator for indicating this Transport Block is lag data; the third status is that the Transport Block has data retransmitted, under this condition, the second indication signal carries a second new transmission indicator for indicating this Transport Block is retransmitted data.

In another optional embodiment, the second indication signal carries a new transmission indicator, wherein, the new transmission indicator may include a first new transmission indicator and a second new transmission indicator. For example, the Transport Block sent through the base station to the first terminal may have two types of status, the first status is that the Transport Block has data initially transmitted, under this condition, the second indication signal carries a first new transmission indicator for indicating this Transport Block is new data; the second status is that the Transport Block has data retransmitted, under this condition, the second indication signal carries a second new transmission indicator for indicating this Transport Block is retransmitted data.

Because the data contained in the third Transport Block is data which is previously planned to be transmitted on the second time-frequency resource from the first Transport Block but has not yet been transmitted to the first terminal, thus, if the base station has not received an HARQ feedback related to the first Transport Block from the first terminal, the data of the third Transport Block is regarded as new data, and the second indication signal carries a first new transmission indicator for indicating that the third Transport Block is new data; if the base station has received an HARQ feedback related to the first Transport Block from the first terminal, the second indication signal carries a second new transmission indicator for indicating that the third Transport Block is retransmitted data.

In an optional scheme, the first new transmission indicator and the second new transmission indicator in the above-mentioned two optional embodiments may practically be expressed with one Bit of new data indicator, specifically, when the Bit value of the new data indicator is 1, it indicates that the new data indicator is the first new transmission indicator, and when the Bit value of the new data indicator is 0, it indicates that the new data indicator is the second new transmission indicator. Alternatively, when the Bit value of the new data indicator is 0, it indicates that the new data indicator is the first new transmission indicator, and when the Bit value of the new data indicator is 1, it indicates that the new data indicator is the second new transmission indicator. That is to say, the first new transmission indicator and the second new transmission indicator contained therein can be transmitted by occupying the same Bit.

Further optionally, the base station determined the new data indicator of a Transport Block to be the first new transmission indicator or the second new transmission indicator according to an HARQ process number. In particular, if the Bit value remains unchanged for the new data indicator of a Transport Block with the same HARQ process number, it indicates that the Transport Block is retransmitted data, i.e. this Bit value expresses the second new transmission indicator; and if the Bit value for the new data indicator suddenly changed, it indicates that the Transport Block is new data, i.e. this Bit value expresses the first new transmission indicator. Alternatively, if the Bit value remains unchanged for the new data indicator of a Transport Block with the same HARQ process number, it indicates that the Transport Block is new data, i.e. this Bit value expresses the first new transmission indicator; and if the Bit value for the new data indicator suddenly changed, it indicates that the Transport Block is retransmitted data, i.e. this Bit value expresses the second new transmission indicator.

The first indication signal and the second indication signal may be sent to the first terminal in the form of an information signal. In an optional embodiment, the first indication signal and the second indication signal are sent to the first terminal via different information signals, and the embodiments have no limitation on the information signals used by the first indication signal and the second indication signal.

For example, the first indication signal and the second indication signal are sent via Downlink Control Information, wherein, the first indication signal is contained in a first Downlink Control Information to be sent to the first terminal, and the second indication signal is contained in a second Downlink Control Information to be sent to the first terminal.

The above-mentioned Downlink Control Information is taken as an example for illustration, optionally, transmission of the second Downlink Control Information is performed at the N^{th} symbol after transmission of the first Downlink Control Information, where N is a positive integer greater than or equal to 1, the symbol is based on a subcarrier spacing of Downlink Control Information of the first terminal.

Alternatively, the first Downlink Control Information and the second Downlink Control Information occupy the same symbol, and the symbol is based on a subcarrier spacing of a control signal of the first terminal.

In another optional embodiment, the first indication signal and the second indication signal are sent to the first terminal via the same information signal. For example, the first indication signal and the second indication signal are sent via Downlink Control Information, in particular, the base station sends a third Downlink Control Information to the first terminal, wherein, the third Downlink Control Information is used for indicating the location of the second time-frequency resource occupied by the second Transport Block or indicating data, which is previously planned to be transmitted on the second time-frequency resource, in the first Transport Block, or a Code Block that the data belongs to, or a Code Block Group that the data belongs to; and the third Downlink Control Information is also used for indicating the location of the third time-frequency resource, in order for the first terminal to receive the third Transport Block according to the indicated location of the third time-frequency resource. Optionally, the third Downlink Control Information carries a subsequent transmission indicator for indicating that the third Transport Block is lag data; or, the third Downlink Control Information carries a new transmission indicator for indicating that the third Transport Block is new data or retransmitted data.

204, the base station sends a mapping relation between the first Transport Block and the third Transport Block to the first terminal.

In particular, the base station also needs to send a mapping relation between the first Transport Block and the third Transport Block to the first terminal, in order for the first terminal to determine the data contained in the third Transport Block corresponds to which part of the data in the first Transport Block. Because a TB comprises at least one CB, and multiple CBs may form a Code Block Group (CBG), and optionally a CB may be divided into at least one Code Block part, therefore, in some embodiments, the mapping relation may be expressed with at least one of CBG, CB and Code Block part.

Optionally, apart from the indication signals in Step 203, the base station may separately sends the mapping relation to the first terminal. Alternatively, the base station may put the mapping relation in the information signal of the second indication signal, so that the mapping relation is sent to the first terminal together with the second indication signal. The embodiments have no limitation on the sending manner of the mapping relation.

Furthermore, the third Transport Block contains the data previously planned to be transmitted on the second time-frequency resource from the first Transport Block. The third Transport Block may only contain the data previously planned to be transmitted on the second time-frequency resource from the first Transport Block; or, it may contain a CB that the data previously planned to be transmitted on the second time-frequency resource from the first Transport Block belongs to; or, it may contain a CBG that the data previously planned to be transmitted on the second time-frequency resource from the first Transport Block belongs to. In order to increase the transmission efficiency for the data previously planned to be transmitted on the second time-frequency resource, a manner with the least data amount to be transmitted may be selected for transmitting the data previously planned to be transmitted on the second time-frequency resource from the first Transport Block. The base station may indicate, in the information signal of the second indication signal, that a CBG, CB or CB-part corresponding to the first Transport Block is included in a basic transmission unit CBG of the third Transport Block. Since the transmitted data is identical to the data previously planned to be transmitted in the first Transport Block, combined decoding is facilitated.

Referring to the Transport Block shown in FIG. 4B, CB4 comprises CB4-part1 and CB4-part2, however, the exact Bits contained in CB4-part1 or CB4-part2 is not fixed. For example, the entire CB4 has 8000 bit, the CB4-part1 may have 3000 bit, and then the CB4-part2 has 5000 bit; the CB4-part1 may also have 4000 bit, and then the CB4-part2 has 4000 bit. These are merely examples, other suitable methods can be used to divide Code Block parts.

In an optional embodiment, the third Transport Block is the data previously planned to be transmitted on the second time-frequency resource. The first Transport Block comprises at least one first Code Block Group, the first Code Block Group comprises at least one first Code Block, and the first Code Block comprises at least one first Code Block part; the third Transport Block comprises at least one third Code Block Group obtained by dividing the data previously planned to be transmitted on the second time-frequency resource, the third Transport Block Group comprises at least one third Code Block, and the third Code Block comprises at least one third Code Block part. The step of sending the mapping relation through the base station to the first terminal specifically comprises sending a first mapping relation through the base station to the first terminal, wherein, the first mapping relation comprises a mapping relation between the third Code Block Group and the first Code Block Group, a mapping relation between the third Code Block and the first Code Block, and a mapping relation between the third Code Block part and the first Code Block part. That is to say, in order to transmit only the data which is previously planned to be transmitted on the occupied time-frequency resource from the first Transport Block, the base station needs to send an indication signal to the first terminal for indicating a mapping relation between the third Transport Block and the data previously planned to be transmitted on the second time-frequency resource in the first Transport Block, so that the data transmission efficiency can be further increased.

For example, referring to the Transport Block shown in FIG. 4B, it is assumed that the data, which is previously planned to be transmitted on the second time-frequency resource from the first Transport Block, in the third Transport Block is CB4-part2, CB5, CB6, CB7-part1. The third Transport Block rearranges this data into CB s and CBGs, for example, this data is arranged into six CBs of CB0-CB5, wherein the first three CBs form CBG1, and the subsequent three CBs form CBG2, with the following mapping relation:

CB0 in CBG1 of the third Transport Block corresponds to CB4-part2 in CBG2 of the first Transport Block;
CB1 and CB2 in CBG1 of the third Transport Block correspond to CB5 in CBG2 of the first Transport Block;
CB3 and CB4 in CBG2 of the third Transport Block correspond to CB6 in CBG3 of the first Transport Block;
CB5 in CBG2 of the third Transport Block corresponds to CB7-part1 in CBG3 of the first Transport Block.

The base station needs to send the above-mentioned mapping relation to the first terminal, and thus the first terminal is informed of a mapping relation between the data in the third Transport Block and CB4-part2, CB5, CB6, CB7-part1 in the first Transport Block, so as to perform combined decoding of the data in the first Transport Block and the data in the third Transport Block, thereby increasing the data transmission efficiency.

In an optional embodiment, the third Transport Block is a Code Block that the data previously planned to be transmitted on the second time-frequency resource belongs to. The first Transport Block comprises at least one first Code Block Group, and the first Code Block Group comprises at least one first Code Block; the third Transport Block comprises at least one third Code Block Group obtained by dividing the data previously planned to be transmitted on the second time-frequency resource, and the third Transport Block Group comprises at least one third Code Block. The step of sending the mapping relation through the base station to the first terminal specifically comprises sending a second mapping relation through the base station to the first terminal, wherein, the second mapping relation comprises a mapping relation between the third Code Block Group and the first Code Block Group, and a mapping relation between the third Code Block and the first Code Block. That is to say, in order to transmit the data which is previously planned to be transmitted on the occupied time-frequency resource from the first Transport Block, wherein the CB that such data belongs to has all its data contained in the third Transport Block, the base station needs to send an indication signal to the first terminal for indicating a mapping relation between the third Transport Block and the data previously planned to be transmitted on the second time-frequency resource in the first Transport Block, so that the data transmission efficiency can be further increased.

For example, referring to the Transport Block shown in FIG. 4B, it is assumed that the data, which is previously planned to be transmitted on the second time-frequency resource from the first Transport Block, in the third Transport Block is CB4-part2, CB5, CB6, CB7-part1. The third Transport Block would transmit the data in CB4, CB5, CB6, CB7 of the first Transport Block, i.e. CB4-part1 and CB7-part2 are additionally included. The third Transport Block rearranges this data into four CBs of CB0-CB3, wherein the first two CBs form CBG1, and the subsequent two CB s form CBG2, with the following mapping relation:

CB0 in CBG1 of the third Transport Block corresponds to CB4 in CBG2 of the first Transport Block;
CB1 in CBG1 of the third Transport Block corresponds to CB5 in CBG2 of the first Transport Block;
CB2 in CBG2 of the third Transport Block corresponds to CB6 in CBG3 of the first Transport Block;
CB3 in CBG2 of the third Transport Block corresponds to CB7 in CBG3 of the first Transport Block.

The base station needs to send the above-mentioned mapping relation to the first terminal, and thus the first terminal is informed of a mapping relation between the data in the third Transport Block and CB4, CB5, CB6, CB7 in the first Transport Block, so as to perform combined decoding of the data in the first Transport Block and the data in the third Transport Block, thereby increasing the data transmission efficiency.

In an optional embodiment, the third Transport Block is a Code Block Group that the data previously planned to be transmitted on the second time-frequency resource belongs to. The first Transport Block comprises at least one first Code Block Group; the third Transport Block comprises at least one third Code Block Group obtained by dividing the data previously planned to be transmitted on the second time-frequency resource. The step of sending the mapping relation through the base station to the first terminal specifically comprises sending a third mapping relation through the base station to the first terminal, wherein, the third mapping relation comprises a mapping relation between the third Code Block Group and the first Code Block Group. That is to say, in order to transmit the data which is previously planned to be transmitted on the occupied time-frequency resource from the first Transport Block, wherein the CBG that such data belongs to has all its data contained in the third Transport Block, the base station needs to send an indication signal to the first terminal for indicating a mapping relation between the third Transport Block and the data previously planned to be transmitted on the second time-frequency resource in the first Transport Block, so that the data transmission efficiency can be further increased.

For example, referring to the Transport Block shown in FIG. 4B, it is assumed that the data, which is previously planned to be transmitted on the second time-frequency resource from the first Transport Block, in the third Transport Block is CB4-part2, CB5, CB6, CB7-part1. The third Transport Block would transmit all the CBs in CBG2 and CBG3 of the first Transport Block, which is the data in CB3 CB4, CB5, CB6, CB7, CB8, i.e. CB3, CB4-part1, CB7-part2 and CB8 are additionally included. The third Transport Block rearranges this data into six CBs of CB0-CB5, wherein the first two CBs form CBG1, and the subsequent two CBs form CBG2, with the following mapping relation:

CBG1 of the third Transport Block corresponds to CBG2 of the first Transport Block;
CBG2 of the third Transport Block corresponds to CBG3 of the first Transport Block.

The base station needs to send the above-mentioned mapping relation to the first terminal, and thus the first terminal is informed of a mapping relation between the data in the third Transport Block and CBG1, CBG2 in the first Transport Block, so as to perform combined decoding of the data in the first Transport Block and the data in the third Transport Block, thereby increasing the data transmission efficiency.

In some embodiments, under the condition that the base station allocates a second time-frequency resource contained in a first time-frequency resource previously allocated to the first terminal is allocated to the second terminal, the base station sends a first indication signal, a second indication signal, a third Transport Block, as well as a mapping relation between the first Transport Block and the third Transport Block, to the first terminal. Wherein, the first time-frequency resource is used for transmitting a first Transport Block of the first terminal, and the second time-frequency resource is used for transmitting a second Transport Block of the second terminal; the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to; the second indication signal is used for indicating a location of a third time-frequency resource allocated to the third Transport Block by the base station; the third Transport Block contains the data, which is previously planned to be transmitted on the second time-frequency resource, from the first Transport Block. In this way, retransmission of the entire first Transport Block through the base station to the first terminal is avoided by means of indicating and transmitting a Transport Block that contains the data which is previously planned to be transmitted on the occupied time-frequency resource to the first terminal, so that the data transmission efficiency is improved. Also, by sending the mapping relation between the first Transport Block and the third Transport Block, combined decoding is facilitated after the first terminal receives the third Transport Block.

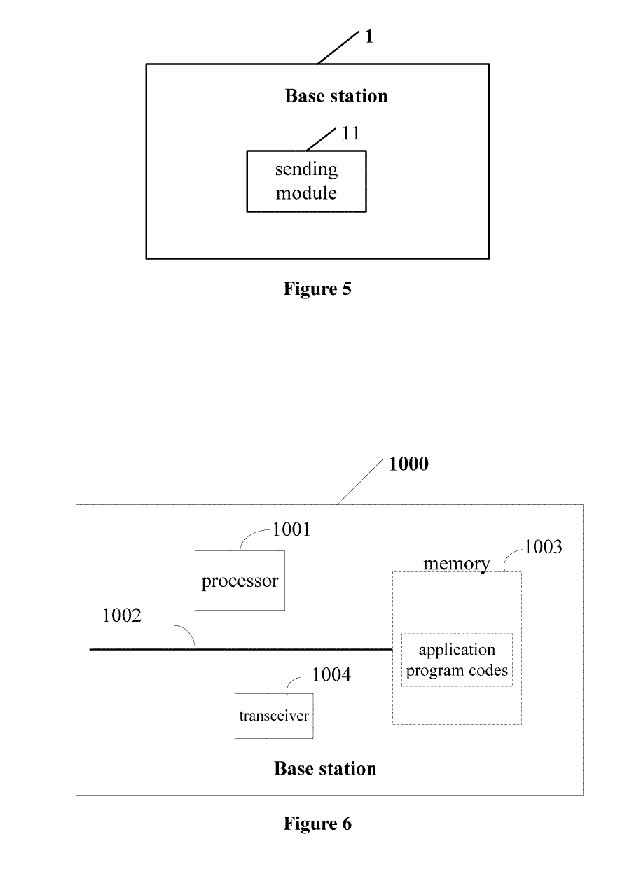

Hereinafter, with reference to FIG. 5 and FIG. 6, the base station consistent with some embodiments of the present disclosure is described in detail. It should be noted that, the base station shown in FIG. 5 and FIG. 6 is for executing the method of the embodiments shown in FIG. 2 to FIG. 4B. For easy illustration, only those parts relevant are shown, and the particular technical details not shown herein can refer to the embodiments shown in FIG. 2 to FIG. 4B.

FIG. 5 is a structural schematic diagram of a base station consistent with some embodiments of the present disclosure. As shown in FIG. 5, the base station 1 comprises a sending module 11.

The sending module 11 is for sending a first indication signal, a second indication signal and a third Transport Block through the base station 1 to a first terminal under the condition that a second time-frequency resource contained in a first time-frequency resource previously allocated to the first terminal is allocated by the base station 1 to a second terminal.

In specific implementation, the base station 1 allocates the first time-frequency resource to a first Transport Block of the first terminal. Wherein, the first Transport Block comprises data and/or Downlink Control Information to be sent to the first terminal, and the base station 1 transmits the first Transport Block to the first terminal via the first time-frequency resource allocated. During the process of transmitting the first Transport Block through the base station 1 to the first terminal via the first time-frequency resource, if a second Transport Block for the second terminal arrives, because of the time-delay requirement corresponding to the second Transport Block or other reasons, the second Transport Block needs to be transmitted timely, therefore, the base station 1 would allocate part of or all of the resource in the first time-frequency resource, which is previously allocated to the first terminal, to the second terminal After the base station 1 allocates part of or all of the resource in the first time-frequency resource to the second terminal, the sending module 11 transmits the second Transport Block to the second terminal via a second time-frequency resource, wherein, the second time-frequency resource refers to the resource allocated to the second terminal from the first time-frequency resource.

In addition, after the first time-frequency resource is occupied by the second terminal, the base station 1 sends a first indication signal, a second indication signal and a third Transport Block to the first terminal. Wherein, the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to; the second indication signal is used for indicating a location of a third time-frequency resource allocated to the third Transport Block by the base station 1; the third Transport Block contains the data, which is previously planned to be transmitted on the second time-frequency resource, from the first Transport Block. In this way, after the first terminal receives the first indication signal, the Code Block Group, Code Block or Code Block part not received in the first Transport Block can be determined, the non-reception may be caused after another Transport Block occupies the time-frequency resource thereof; subsequently, after the first terminal receives the second indication signal, the location of the third time-frequency resource of the third Transport Block can be notified, and thus the third Transport Block can be received according to the location of the third time-frequency resource notified. In this way, after the first time-frequency resource for the first terminal is occupied by another Transport Block, the data integrity can be ensured by transmitting a Transport Block that contains the data which is previously planned to be transmitted on the occupied time-frequency resource, this avoids retransmitting the entire first Transport Block to the first terminal, and thus the data transmission efficiency is increased.

Optionally, the base station 1 uses Downlink Control Information (DCI) to announce the location of the first time-frequency resource allocated to the first Transport Block, in particular: the sending module 11 sends a fourth Downlink Control Information to the first terminal, wherein the fourth Downlink Control Information is for indicating the location of the first time-frequency resource, in order for the first terminal to receive the first Transport Block according to the indicated location of the first time-frequency resource.

Optionally, the base station 1 uses DCI to announce the location of the second time-frequency resource allocated to the second Transport Block, in particular: the sending module 11 sends a fifth Downlink Control Information to the second terminal, wherein the fifth Downlink Control Information is for indicating the location of the second time-frequency resource, in order for the second terminal to receive the second Transport Block according to the indicated location of the second time-frequency resource.

In an optional embodiment, the second indication signal contains a subsequent transmission indicator for indicating that the third Transport Block is lag data.

In another optional embodiment, under the condition that an HARQ ACK/NACK feedback related to the first Transport Block is not received from the first terminal before the base station 1 sends the second indication signal and the third Transport Block to the first terminal, the second indication signal carries a first new transmission indicator for indicating that the third Transport Block is new data.

In another optional embodiment, under the condition that an HARQ ACK/NACK feedback related to the first Transport Block is received from the first terminal before the base station 1 sends the second indication signal and the third Transport Block to the first terminal, the second indication signal carries a second new transmission indicator for indicating that the third Transport Block is retransmitted data.

In an optional embodiment, the first indication signal and the second indication signal are sent to the first terminal via different information signals, and the embodiments have no limitation on the information signals used by the first indication signal and the second indication signal. For example, the first indication signal and the second indication signal are sent via Downlink Control Information, wherein, the first indication signal is contained in a first Downlink Control Information to be sent to the first terminal, and the second indication signal is contained in a second Downlink Control Information to be sent to the first terminal.

In another optional embodiment, the first indication signal and the second indication signal are sent to the first terminal via the same information signal. For example, the first indication signal and the second indication signal are sent via Downlink Control Information, in particular, the sending module 11 sends a third Downlink Control Information to the first terminal, wherein, the third Downlink Control Information is used for indicating the location of the second time-frequency resource occupied by the second Transport Block or indicating data, which is previously planned to be transmitted on the second time-frequency resource, in the first Transport Block, or a Code Block that the data belongs to, or a Code Block Group that the data belongs to; and the third Downlink Control Information is also used for indicating the location of the third time-frequency resource, in order for the first terminal to receive the third Transport Block according to the indicated location of the third time-frequency resource. Optionally, the third Downlink Control Information carries a subsequent transmission indicator for indicating that the third Transport Block is lag data; or, the third Downlink Control Information carries a new transmission indicator.

Wherein, the new transmission indicator can be classified into a first new transmission indicator and a second new transmission indicator, in particular: under the condition that an HARQ ACK/NACK feedback related to the first Transport Block is not received from the first terminal before the base station 1 sends the second indication signal and the third Transport Block to the first terminal, the third indication signal carries a first new transmission indicator for indicating that the third Transport Block is new data; under the condition that an HARQ ACK/NACK feedback related to the first Transport Block is received from the first terminal before the base station 1 sends the second indication signal and the third Transport Block to the first terminal, the third indication signal carries a second new transmission indicator for indicating that the third Transport Block is retransmitted data.

Furthermore, optionally, the third Transport Block contains the data previously planned to be transmitted on the second time-frequency resource from the first Transport Block. The third Transport Block may only contain the data previously planned to be transmitted on the second time-frequency resource from the first Transport Block; or, it may contain a CB that the data previously planned to be transmitted on the second time-frequency resource from the first Transport Block belongs to; or, it may contain a CBG that the data previously planned to be transmitted on the second time-frequency resource from the first Transport Block belongs to. In order to increase the transmission efficiency for the data previously planned to be transmitted on the second time-frequency resource, a manner with the least data amount to be transmitted may be selected for transmitting the data previously planned to be transmitted on the second time-frequency resource from the first Transport Block. The base station 1 may indicate, in the information signal of the second indication signal, that a CBG, CB or CB-part corresponding to the first Transport Block is included in a basic transmission unit CBG of the third Transport Block. Since the transmitted data is identical to the data previously planned to be transmitted in the first Transport Block, combined decoding is facilitated.

It can be understood that, the specific implementation ways of the functional blocks comprised in the base station 1 of FIG. 5 can refer to the aforementioned embodiments, which are not repeatedly described herein.

In some embodiments, under the condition that the base station allocates a second time-frequency resource contained in a first time-frequency resource previously allocated to the first terminal is allocated to the second terminal, the base station sends a first indication signal, a second indication signal and a third Transport Block to the first terminal. Wherein, the first time-frequency resource is used for transmitting a first Transport Block of the first terminal, and the second time-frequency resource is used for transmitting a second Transport Block of the second terminal; the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to; the second indication signal is used for indicating a location of a third time-frequency resource allocated to the third Transport Block by the base station; the third Transport Block contains the data, which is previously planned to be transmitted on the second time-frequency resource, from the first Transport Block. In this way, retransmission of the entire first Transport Block through the base station to the first terminal is avoided by means of indicating and transmitting a Transport Block that contains the data which is previously planned to be transmitted on the occupied time-frequency resource to the first terminal, so that the data transmission efficiency is improved.

The base station of the embodiment shown in FIG. 5 can be implemented by the base station shown in FIG. 6. As shown in FIG. 6, which is a structural schematic diagram of a base station consistent with the embodiments of the present disclosure, the base station 1000 comprises: a processor 1001 and a transceiver 1004, wherein the processor 1001 and the transceiver 1004 are interconnected, for example via a bus line 1002. Optionally, the base station 1000 may also comprise a memory 1003. It should be noted that, there is at least one transceiver 1004 in practical application, and the architecture of the base station 1000 is not limited to a particular type.

The processor 1001 may be a Central Processing Unit (CPU), a general processor, a Digital Signal Processor (DSP), an Application Specific Integrated Circuit (ASIC), a Field Programmable Gate Array (FPGA), or other programmable logic devices, transistor logic devices, hardware components, or a combination of any of the above, which can implement or execute the various illustrative logic blocks, modules and circuits described in the disclosure of the present application. The processor 1001 may also be a combination for realizing computing functions, for example, a combination of one or more microprocessors, or a combination of DSPs and microprocessors.

The bus line 1002 may comprise a pathway for transmitting information between the above-mentioned components. The bus line 1002 may be a Peripheral Component Interconnect (PCI) bus line or an Extended Industry Standard Architecture (EISA) bus line. The bus line can be classified into an address bus line, a data bus line and a control bus line. For easy depiction, FIG. 6 uses only one thick line to show it, but this does not mean there is only one bus line or one type of bus line.

The memory 1003 may be a Read-Only Memory (ROM) or other types of static storage devices capable of storing static information and instructions, a Random Access Memory (RAM) or other types of dynamic storage devices capable of storing information and instructions, or may be an Electrically Erasable Programmable Read-Only Memory (EEPROM), Compact Disk Read-Only Memory (CD-ROM) or other optical disk storage media, optical Disk storage media (including Compact Disk, laser Disk, optical Disk, Digital Versatile Disk, Bluelight Disk), a magnetic disk storage medium or other magnetic disk storage devices, or any other media capable of carrying or storing the desired program codes with instructions and data structure forms and capable of being accessed by a computer, but is not limited to these.

Optionally, the memory 1003 stores application program codes for executing the scheme of the present application, which is controlled and executed by the processor 1001. The processor 1001 executes the application program codes stored in the memory 1003, so as to implement the operations of the base station provided by any embodiment shown in FIG. 2 to FIG. 4B, which comprises:

Under the condition that a second time-frequency resource contained in a first time-frequency resource previously allocated to the first terminal is allocated by the base station to a second terminal, the processor 1001 sends a first indication signal, a second indication signal and a third Transport Block through the transceiver 1004 to a first terminal.

Wherein, the first time-frequency resource is used for transmitting a first Transport Block of the first terminal, and the second time-frequency resource is used for transmitting a second Transport Block of the second terminal; the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to; the second indication signal is used for indicating a location of a third time-frequency resource allocated to the third Transport Block by the base station; the third Transport Block contains the data, which is previously planned to be transmitted on the second time-frequency resource, from the first Transport Block.

In an optional embodiment, the second indication signal contains a subsequent transmission indicator for indicating that the third Transport Block is lag data.

In an optional embodiment, under the condition that an HARQ ACK/NACK feedback related to the first Transport Block is not received from the first terminal before the base station sends the second indication signal and the third Transport Block to the first terminal, the second indication signal carries a first new transmission indicator for indicating that the third Transport Block is new data.

In an optional embodiment, under the condition that an HARQ ACK/NACK feedback related to the first Transport Block is received from the first terminal before the base station sends the second indication signal and the third Transport Block to the first terminal, the second indication signal carries a second new transmission indicator for indicating that the third Transport Block is retransmitted data.

In an optional embodiment, the first indication signal is contained in a first Downlink Control Information to be sent to the first terminal; and the second indication signal is contained in a second Downlink Control Information to be sent to the first terminal.

In an optional embodiment, transmission of the second Downlink Control Information is performed at the N^{th} symbol after transmission of the first Downlink Control Information, where N is a positive integer greater than or equal to 1, the symbol is based on a subcarrier spacing of a control signal of the first terminal.

In an optional embodiment, the first Downlink Control Information and the second Downlink Control Information occupy the same symbol, and the symbol is based on a subcarrier spacing of a control signal of the first terminal.

In an optional embodiment, the first indication signal and the second indication signal are contained in a third Downlink Control Information to be sent to the first terminal.

In an optional embodiment, the third Transport Block is the data previously planned to be transmitted on the second time-frequency resource. The first Transport Block comprises at least one first Code Block Group, the first Code Block Group comprises at least one first Code Block, and the first Code Block comprises at least one first Code Block part; the third Transport Block comprises at least one third Code Block Group obtained by dividing the data previously planned to be transmitted on the second time-frequency resource, the third Transport Block Group comprises at least one third Code Block, and the third Code Block comprises at least one third Code Block part;

the processor 1001 sends a first mapping relation through the transceiver 1004 to the first terminal, wherein, the first mapping relation comprises a mapping relation between the third Code Block Group and the first Code Block Group, a mapping relation between the third Code Block and the first Code Block, and a mapping relation between the third Code Block part and the first Code Block part.

In an optional embodiment, the third Transport Block is a Code Block that the data previously planned to be transmitted on the second time-frequency resource belongs to. The first Transport Block comprises at least one first Code Block Group, and the first Code Block Group comprises at least one first Code Block; the third Transport Block comprises at least one third Code Block Group obtained by dividing the data previously planned to be transmitted on the second time-frequency resource, and the third Transport Block Group comprises at least one third Code Block; the processor 1001 sends a second mapping relation through the transceiver 1004 to the first terminal, wherein, the second mapping relation comprises a mapping relation between the third Code Block Group and the first Code Block Group, and a mapping relation between the third Code Block and the first Code Block.

In an optional embodiment, the third Transport Block is a Code Block Group that the data previously planned to be transmitted on the second time-frequency resource belongs to. The first Transport Block comprises at least one first Code Block Group; the third Transport Block comprises at least one third Code Block Group obtained by dividing the data previously planned to be transmitted on the second time-frequency resource; the processor 1001 sends a third mapping relation through the transceiver 1004 to the first terminal, wherein, the third mapping relation comprises a mapping relation between the third Code Block Group and the first Code Block Group.

It can be understood that, the specific implementation ways of the operations or steps executed by the processor 1001 of the base station 1000 of FIG. 6 can refer to the aforementioned embodiments, which are not repeatedly described herein.

The aforementioned embodiments may be implemented by software, hardware, firmware or a combination of any of the above. When they are implemented by software, they may be completely or partially implemented in the form of a computer program product. The computer program product comprises one or more computer instructions. When the computer program instructions are loaded and executed on a computer, the process steps or functions according to some embodiments are completely or partially generated. The computer may be a general purpose computer, a dedicated computer, a computer network, or other programmable devices. The computer instructions may be stored in a computer readable storage medium or be transmitted from a computer readable storage medium to another computer readable storage medium, for example, the computer instructions can be transmitted from one website, computer, server or data center to another website, computer, server or data center via wired means (such as a coaxial cable, an optical fiber cable, a Digital Subscriber Line (DSL)) or wireless means (such as infrared, wireless waves or microwaves). The computer readable storage medium may be any usable medium capable of being accessed by a computer, or a data storage device such as a server, a data center integrated with one or more usable storage medium. The usable storage medium may be a magnetic medium (such as a floppy disk, a hard disk, a magnetic tape), an optical medium (such as a DVD), or a semiconductor medium (such as a Solid State Disk (SSD)).

As can be understood by a person skilled in the art, all of or part of the steps in the above-described method embodiments can be implemented by related hardware with instructions of a computer program, the program can be stored in a computer readable storage medium, and when the program is executed, it performs the steps of the above-described method embodiments. Wherein, the storage medium may be a magnetic disk, an optical Disk, a Read-Only Memory (ROM) or a Random Access Memory (RAM).

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A data transmission method, wherein, the method comprises:
sending a first indication signal, a second indication signal and a third Transport Block through a base station to a first terminal under the condition that a second time-frequency resource contained in a first time-frequency resource previously allocated to the first terminal is allocated to a second terminal,
wherein, the first time-frequency resource is used for transmitting a first Transport Block of the first terminal, and the second time-frequency resource is used for transmitting a second Transport Block of the second terminal;
the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to;
the second indication signal is used for indicating a location of a third time-frequency resource allocated to the third Transport Block by the base station; the third Transport Block contains the data, which is previously planned to be transmitted on the second time-frequency resource, from the first Transport Block.

2. The method according to claim 1, wherein, the second indication signal contains a subsequent transmission indicator for indicating that the third Transport Block is lag data.

3. The method according to claim 1, wherein, under the condition that an HARQ ACK/NACK feedback related to the first Transport Block is not received from the first terminal before the base station sends the second indication signal and the third Transport Block to the first terminal, the second indication signal carries a first new transmission indicator for indicating that the third Transport Block is new data.

4. The method according to claim 1, wherein, under the condition that an HARQ ACK/NACK feedback related to the first Transport Block is received from the first terminal before the base station sends the second indication signal and the third Transport Block to the first terminal, the second indication signal carries a second new transmission indicator for indicating that the third Transport Block is retransmitted data.

5. The method according to claim 1, wherein, the first indication signal is contained in a first Downlink Control Information to be sent to the first terminal; and the second indication signal is contained in a second Downlink Control Information to be sent to the first terminal.

6. The method according to claim 5, wherein,
transmission of the second Downlink Control Information is performed at the N^{th} symbol after transmission of the first Downlink Control Information, where N is a positive integer greater than or equal to 1, the symbol is based on a subcarrier spacing of a control signal of the first terminal; or
the first Downlink Control Information and the second Downlink Control Information occupy the same symbol, and the symbol is based on a subcarrier spacing of a control signal of the first terminal.

7. The method according to claim 1, wherein, the first indication signal and the second indication signal are contained in a third Downlink Control Information to be sent to the first terminal.

8. The method according to claim 1, wherein, the third Transport Block is the data previously planned to be transmitted on the second time-frequency resource.

9. The method according to claim 8, wherein,
the first Transport Block comprises at least one first Code Block Group, the first Code Block Group comprises at least one first Code Block, and the first Code Block comprises at least one first Code Block part;
the third Transport Block comprises at least one third Code Block Group obtained by dividing the data previously planned to be transmitted on the second time-frequency resource, the third Transport Block Group comprises at least one third Code Block, and the third Code Block comprises at least one third Code Block part;
the method further comprises:
sending a first mapping relation through the base station to the first terminal, wherein, the first mapping relation comprises a mapping relation between the third Code Block Group and the first Code Block Group, a mapping relation between the third Code Block and the first Code Block, and a mapping relation between the third Code Block part and the first Code Block part.

10. The method according to claim 1, wherein, the third Transport Block is a Code Block that the data previously planned to be transmitted on the second time-frequency resource belongs to.

11. The method according to claim 10, wherein,
the first Transport Block comprises at least one first Code Block Group, and the first Code Block Group comprises at least one first Code Block;
the third Transport Block comprises at least one third Code Block Group obtained by dividing the data previously planned to be transmitted on the second time-frequency resource, and the third Transport Block Group comprises at least one third Code Block;
the method further comprises:
sending a second mapping relation through the base station to the first terminal, wherein, the second mapping relation comprises a mapping relation between the third Code Block Group and the first Code Block Group, and a mapping relation between the third Code Block and the first Code Block.

12. The method according to claim 1, wherein, the third Transport Block is a Code Block Group that the data previously planned to be transmitted on the second time-frequency resource belongs to.

13. The method according to claim 12, wherein,
the first Transport Block comprises at least one first Code Block Group;
the third Transport Block comprises at least one third Code Block Group obtained by dividing the data previously planned to be transmitted on the second time-frequency resource;
the method further comprises:
sending a third mapping relation through the base station to the first terminal, wherein, the third mapping relation comprises a mapping relation between the third Code Block Group and the first Code Block Group.

14. A base station, wherein, the base station comprises a processor, a memory and a transceiver interconnected by a bus line, the transceiver is for sending and receiving data, the memory is for storing program codes, the processor is for calling the program codes stored in the memory to execute the following steps:
sending a first indication signal, a second indication signal and a third Transport Block to a first terminal under the condition that a second time-frequency resource contained in a first time-frequency resource previously allocated to the first terminal is allocated by the base station to a second terminal;
wherein, the first time-frequency resource is used for transmitting a first Transport Block of the first terminal, and the second time-frequency resource is used for transmitting a second Transport Block of the second terminal;
the first indication signal is used for indicating the location of the second time-frequency resource occupied by the second Transport Block; or, the first indication signal is used for indicating data, which is previously planned to be transmitted on the second time-frequency resource, in the first Transport Block, or a Code Block that the data belongs to, or a Code Block Group that the data belongs to;
the second indication signal is used for indicating a location of a third time-frequency resource allocated to the third Transport Block by the base station; the third Transport Block contains the data, which is previously planned to be transmitted on the second time-frequency resource, from the first Transport Block.

15. The base station according to claim 14, wherein,
the second indication signal carries a subsequent transmission indicator for indicating that the third Transport Block is lag data; or
under the condition that an HARQ ACK/NACK feedback related to the first Transport Block is not received from the first terminal before the base station sends the second indication signal and the third Transport Block to the first terminal, the second indication signal carries a first new transmission indicator for indicating that the third Transport Block is new data; or
under the condition that an HARQ ACK/NACK feedback related to the first Transport Block is received from the first terminal before the base station sends the second indication signal and the third Transport Block to the first terminal, the second indication signal carries a second new transmission indicator for indicating that the third Transport Block is retransmitted data.

16. The base station according to claim 14, wherein, the first indication signal is contained in a first Downlink Control Information to be sent to the first terminal; and the second indication signal is contained in a second Downlink Control Information to be sent to the first terminal,
transmission of the second Downlink Control Information is performed at the N^{th} symbol after transmission of the first Downlink Control Information, where N is a positive integer greater than or equal to 1, the symbol is based on a subcarrier spacing of a control signal of the first terminal; or
the first Downlink Control Information and the second Downlink Control Information occupy the same symbol, the symbol is based on a subcarrier spacing of a control signal of the first terminal.

17. The base station according to claim 14, wherein, the first indication signal and the second indication signal are contained in a third Downlink Control Information to be sent to the first terminal.

18. The base station according to claim 14, wherein, the third Transport Block is the data previously planned to be transmitted on the second time-frequency resource,
the first Transport Block comprises at least one first Code Block Group, the first Code Block Group comprises at least one first Code Block, and the first Code Block comprises at least one first Code Block part;
the third Transport Block comprises at least one third Code Block Group obtained by dividing the data previously planned to be transmitted on the second time-frequency resource, the third Transport Block Group comprises at least one third Code Block, and the third Code Block comprises at least one third Code Block part;
the processor is further for sending a first mapping relation to the first terminal, wherein, the first mapping relation comprises a mapping relation between the third Code Block Group and the first Code Block Group, a mapping relation between the third Code Block and the first Code Block, and a mapping relation between the third Code Block part and the first Code Block part.

19. The base station according to claim 14, wherein, the third Transport Block is a Code Block that the data previously planned to be transmitted on the second time-frequency resource belongs to,
the first Transport Block comprises at least one first Code Block Group, and the first Code Block Group comprises at least one first Code Block;
the third Transport Block comprises at least one third Code Block Group obtained by dividing the data previously planned to be transmitted on the second time-frequency resource, and the third Transport Block Group comprises at least one third Code Block;
the processor is further for sending a second mapping relation to the first terminal, wherein, the second mapping relation comprises a mapping relation between the third Code Block Group and the first Code Block Group, and a mapping relation between the third Code Block and the first Code Block.

20. The base station according to claim 14, wherein, the third Transport Block is a Code Block Group that the data previously planned to be transmitted on the second time-frequency resource belongs to,
the first Transport Block comprises at least one first Code Block Group;
the third Transport Block comprises at least one third Code Block Group obtained by dividing the data previously planned to be transmitted on the second time-frequency resource;
the processor is further for sending a third mapping relation to the first terminal, wherein, the third mapping relation comprises a mapping relation between the third Code Block Group and the first Code Block Group.
